(19) United States
(12) Patent Application Publication
(10) Pub. No.: US 2024/0350973 A1
(43) Pub. Date: Oct. 24, 2024

(54) METHOD AND SYSTEM FOR SEPARATING A TRITIATED HEAVY WATER STREAM INTO A TRITIUM-LEAN HEAVY WATER STREAM AND A TRITIUM-ENRICHED HEAVY WATER STREAM

(71) Applicant: LAURENTIS ENERGY PARTNERS INC., Toronto (CA)

(72) Inventor: Paul KWON, Pickering (CA)

(21) Appl. No.: 18/682,688

(22) PCT Filed: Aug. 8, 2022
(86) PCT No.: PCT/CA2022/051208

§ 371 Date: Feb. 9, 2024

Related U.S. Application Data
(60) Provisional application No. 63/231,090, filed on Aug. 9, 2021.

(51) Int. Cl. B01D 59/40; B01D 59/28; C25B 1/04; C25B 9/17

(52) U.S. Cl. CPC B01D 59/40; B01D 59/28; C25B 1/04; C25B 9/17

(57) ABSTRACT

A system, apparatus and process for separating a tritiated heavy water stream into a tritium-lean heavy water stream and a tritium-enriched heavy water stream. Tritiated heavy water (DTO/D2O) is fed to a mid-point of an isotope exchange column. The column contains a hydrophobic solid catalyst to promote exchange of deuterium and tritium. DT/D2 gas flows out of an electrolysis cell and into the first end of the column, concentrating tritium content in the heavy water by counter current flow to produce a tritium-rich heavy water below the feed point and a tritium-lean deuterium gas above. Tritium-rich heavy water flows out the first end of the column and into the electrolysis cell, forming DT/D2 gas and a tritium-enriched heavy water stream. Tritium-lean deuterium gas flows out the second end of the column and into a tritium-lean heavy water unit. Either O2 gas or light water additionally flows into the tritium-lean heavy water unit to form a tritium-lean heavy water.

### CROSS-REFERENCE TO RELATED APPLICATION

This application claims priority to U.S. Provisional application No. 63/231,090 filed Aug. 9, 2021, which is hereby incorporated by reference in its entirety.

### TECHNICAL FIELD

The present invention relates to a system, method and apparatus for separating a tritiated heavy water stream into a tritium-lean heavy water stream and a tritium-enriched heavy water stream.

### BACKGROUND

In nuclear power reactors of the type using heavy water as coolant and moderator, there is a progressive build-up of tritiated heavy water (DTO) in the D2O because this DTO is continuously produced from neutron capture in deuterium. At present, the removal of tritium from water is accomplished by various hydrogen separation techniques, e.g. water distillation, cryogenic distillation of hydrogen, etc. which will immobilize tritium.

However, known methods and systems for removing tritium from heavy water are deficient. For instance, methods and systems using vapour phase catalytic exchange (VPCE) and cryogenic distillation are not able to remove tritium from heavy water moderator water to levels low enough to avoid environmental contamination and also these methods and systems can cause a buildup of ¹⁷O which results in accumulation of ¹⁴C in the reactor moderator (which is undesirable for occupational exposure for personnel). Accordingly, there is a need for improved methods and systems for that can remove tritium from heavy water in order to provide sufficiently low levels to avoid environmental contamination and to reduce the buildup of ¹⁷O and the accumulation of ¹⁴C in the reactor moderator.

### SUMMARY OF THE INVENTION

It is an embodiment of the present invention to provide a system, an apparatus, and process for removing tritium from heavy water to at least near environment levels that are virtually free of all other radioactive elements. In some aspects, the present invention relates to a system, an apparatus, and process for use with a CANDU (Canada Deuterium Uranium) plant with an existing TRF (Tritium Removal Facility) to further detritiate heavy water and provide beneficial tritium and ¹⁴C management.

It is an embodiment of the present invention to provide a process for separating a tritiated heavy water stream into a tritium-lean heavy water stream and a tritium-enriched heavy water stream, the process comprising:
flowing a tritiated heavy water (DTO/D2O) feed to a feed point of an isotope exchange column, said feed point being between a first end below the feed point and a second end above the feed point, said column containing a hydrophobic solid catalyst configured to promote exchange of deuterium and tritium;
flowing a DT/D2 gas out of an electrolysis cell and into the first end of the column;
concentrating, in the column, tritium content in the tritiated heavy water by counter current flow of the DT/D2 gas from the first end to the second end, to produce a tritium-rich heavy water below the feed point and a tritium-lean deuterium gas above the feed point;
flowing the tritium-rich heavy water out the first end of the column and into the electrolysis cell;
forming, in the electrolysis cell, the DT/D2 gas and a tritium-enriched heavy water stream;
flowing the tritium-lean deuterium gas out the second end of the column and into a D2/O2 recombiner;
flowing an O2 gas into the D2/O2 recombiner; and
forming, in the D2/O2 recombiner, a tritium-lean heavy water stream.

In one aspect the process further comprises refluxing a portion of the tritium-lean heavy water stream back into the second end of the column.

In one aspect the process further comprises
diverting another portion of the tritium-lean heavy water stream away to a remote site. In one aspect the process the flowing the tritium-enriched heavy water stream back to a source of the tritiated heavy water stream.

In one aspect the source of the tritiated heavy water stream comprises a vapor phase catalytic exchange column (VPCE) configured to receive the tritium-enriched heavy water stream.

In one aspect the hydrophobic solid catalyst is a platinum-based hydrophobic solid catalyst.

In one aspect the process the D2/O2 recombiner is a D2/O2 overhead recombiner.

In one aspect the process the feed point is about mid-way between the first end and the second end.

In one aspect the process the forming, in the electrolysis cell, produces an oxygen gas.

In one aspect the process further comprises diverting the produced oxygen gas away from the electrolysis cell.

In one aspect the produced oxygen gas comprises ¹⁷O.

In one aspect the isotope exchange column comprises a plurality of isotope exchange columns.

In one aspect the plurality of isotope exchange columns comprise: a first LCPE configured for receiving the tritiated heavy water (DTO/D2O) feed and flowing the tritium-rich heavy water out the first end of the column, a second LPCE emplaced between the first LPCE and the second end and fluidly connected to the first LPCE, and a third LPCE emplaced between the second LPCE and the second end and fluidly connected to the second LPCE and configured for flowing the tritium-lean deuterium gas into the D2/O2 recombiner and for receiving the portion of the tritium-lean heavy water stream from the D2/O2 recombiner.

It is an embodiment of the present invention to provide a process for separating a tritiated heavy water stream into a tritium-lean heavy water stream and a tritium-enriched heavy water stream, the process comprising:
flowing a tritiated heavy water (DTO/D2O) feed to a feed point of an isotope exchange column, said feed point being between a first end below the feed point and a second end above the feed point, said column containing a hydrophobic solid catalyst configured to promote exchange of deuterium and tritium;
flowing a DT/D2 gas out of an electrolysis cell and into the first end of the column;
concentrating, in the column, tritium content in the tritiated heavy water by counter current flow of the DT/D2 gas from the first end to the second end, to produce a tritium-rich heavy water below the feed point and a tritium-lean deuterium gas above the feed point;
flowing the tritium-rich heavy water out the first end of the column and into the electrolysis cell;
forming, in the electrolysis cell, the DT/D2 gas and a tritium-enriched heavy water stream;
flowing the tritium-lean deuterium gas out the second end of the column and into a light water/heavy water isotopic exchange column;
flowing light water into the light water/heavy water isotopic exchange column; and
forming, in the light water/heavy water isotopic exchange column, a tritium-lean heavy water stream.

It is an embodiment of the present invention to provide a process for producing a tritium-lean heavy water stream, the process comprises: providing a source of tritiated heavy water; flowing the tritiated heavy water into an isotope exchange column; enriching tritium concentration in the tritiated heavy water to produce, in the isotope exchange column, a tritium-enriched heavy water stream and a tritium-lean deuterium gas; combining the tritium-lean deuterium gas with oxygen gas to produce a tritium-lean heavy water stream.

It is an embodiment of the present invention to provide a system for producing a tritium-lean heavy water stream comprising:
a source of tritiated heavy water (DTO/D2O);
an isotope exchange column containing a hydrophobic solid catalyst, and configured for receiving tritiated heavy water (DTO/D2O) from the source, the column configured to promote exchange of deuterium and tritium to produce a tritium-rich heavy water and a tritium-lean deuterium gas;
an electrolysis cell configured for producing a DT/D2 gas and for flowing the DT/D2 gas into the isotope exchange column and configured for receiving the tritium-rich heavy water from the isotope exchange column and producing a tritium-enriched heavy water stream for flowing back to the source of tritiated heavy water (DTO/D2O); and a tritium-lean heavy water unit configured for receiving the tritium-lean deuterium gas flowed from isotope exchange column and for receiving an O2 gas or light water, to form the tritium-lean heavy water stream.

### BRIEF DESCRIPTION OF THE DRAWINGS

FIG. 1 is a flow diagram illustrating the combined tritium removal processes in accordance with an embodiment of the invention;

FIG. 2 is a flow diagram of a process for separating tritiated heavy water into a tritium-reduced stream and a tritium-enriched stream in accordance with an embodiment of the invention; and

FIG. 3 is a flow diagram of a process for separating tritiated heavy water into a tritium-reduced stream and a tritium-enriched stream in accordance with another embodiment of the invention comprising a plurality of liquid phase catalytic exchange columns (LPCEs) in accordance with an embodiment of the invention; and

FIG. 4 is a flow diagram of a process for separating tritiated heavy water into a tritium-reduced stream and a tritium-enriched stream in accordance with another embodiment of the invention comprising a plurality of LPCEs and a light water/heavy water isotopic exchange column in accordance with an embodiment of the invention.

### DETAILED DESCRIPTION

Reference will be made below in detail to exemplary embodiments of the invention, examples of which are illustrated in the accompanying drawings. Wherever possible, the same reference numerals used throughout the drawings refer to the same or like parts.

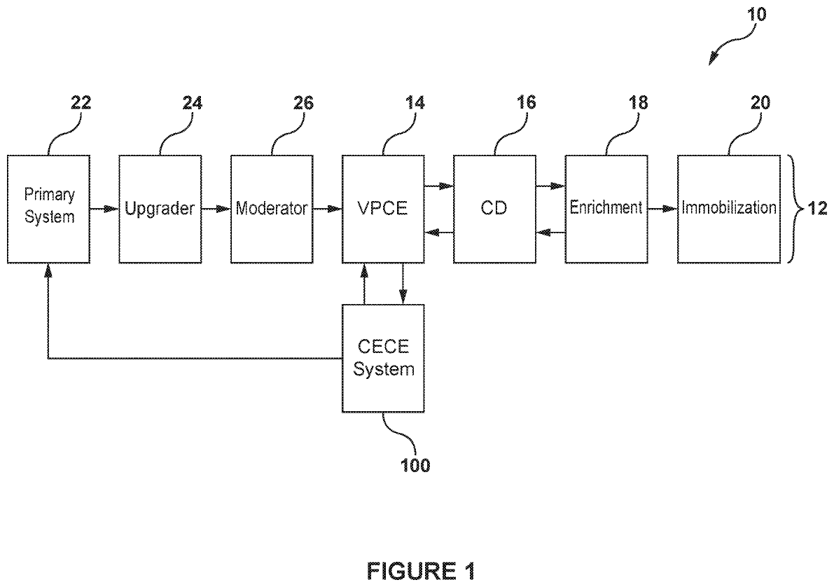

FIG. 1 illustrates provides a general overview of a system useful for the combined tritium removal process of the present disclosure. Tritium removal process 10 carried out at tritium removal facility (TRF) 12 (or similar) includes various sections including a vapor phase catalytic exchange column (VPCE) 14, a cryogenic distillation (CD) 16, enrichment 18, immobilization 20, a primary heat transport system 22, a heavy water upgrader 24, a moderator 26, and a Combined Electrolysis Catalytic Exchange (CECE) apparatus 100.

The primary heat transport system 22 circulates pressurized heavy water coolant through the reactor fuel channels (not shown) to remove heat produced by fission of natural uranium fuel. The heavy water upgrader 24 separates heavy water from a mixture of light water and heavy water to yield a product containing a sufficiently high isotopic concentration of heavy water to be used in the moderator 26. The moderator 26 can be a standard CANDU (Canada Deuterium Uranium) moderator for heavy water, used to control/moderate the neutrons released from the fission reaction to sustain the chain reaction.

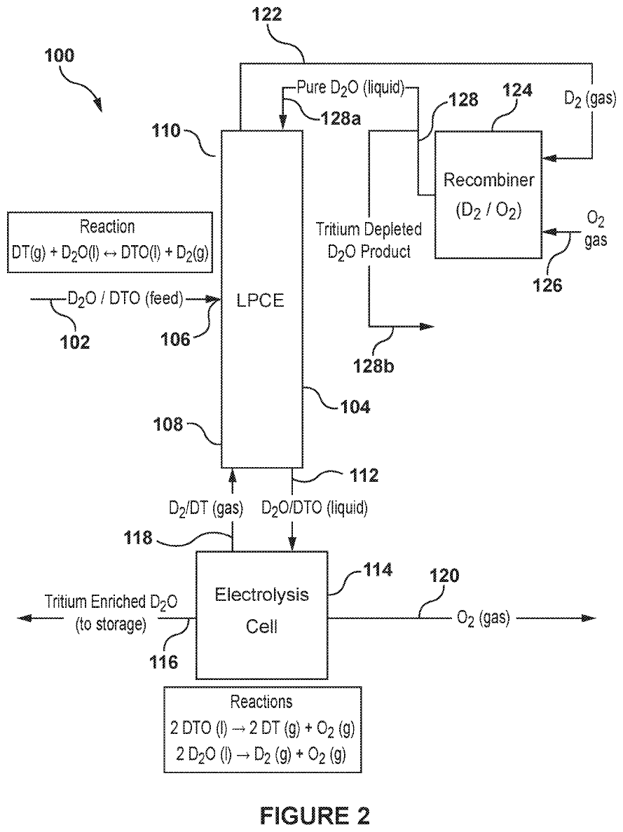

FIG. 2 illustrates, according to one embodiment, the CECE process and CECE apparatus 100 for separating tritiated heavy water into a tritium-lean heavy water stream and a tritium-enriched heavy water stream. As shown, the VPCE 14 of the TRF 12 provides a source of tritiated heavy water (a mixture of DTO/D2O) feed 102 into a liquid phase catalytic exchange column (LPCE) 104.

As shown in FIG. 2, the LPCE column 104 includes a feed point 106 which is positioned above a first end 108 of the LPCE column 104 and below a second end 110 of the column 104. In some aspects, the feed point 106 is located about mid-way between the first end 108 and second end 110 and at a position that will result in a tritium concentration of heavy water that matches the water isotopic as an input to the VPCE 14 and CD 16 of the TRF 12 (as will be further described in detail below).

The LPCE 104 is a countercurrent column that is packed with a hydrophobic solid catalyst. In one aspect, the hydrophobic solid catalyst is a platinum-based hydrophobic solid catalyst. In some aspects, the LPCE 104 is packed with any type of catalyst that is water-repellent and consists of at least one catalytically active metal selected from Group VIII of the Periodic Table having a substantially liquid-water-repellant organic resin or polymer coating thereon which is permeable to water vapour and hydrogen gas. In some aspects, the liquid-water-repellant organic resin or polymer coating are polyflurocarbons, hydrophobic hydrocarbon polymers of medium to high molecular weight, or silicones. Examples of catalysts include group VIII metals: Pt, Ni, Ir, Rh and Pd and Catalyst support: carbon, graphite, charcoal, alumina (Al₂ O₃), magnesia, silica (SiO₂), silica gel, chromia (Cr₂ O₃), nickel oxide (NiO); and substantially liquid-water-repellent coating: polytetrafluoroethylene is a preferred waterproof coating. Other waterproof coatings are for example, silicone resins consisting of semi-polymerized methyl siloxanes with some percentage of silanol, methoxy or ethoxy, groups attached to the siloxane structure. Usually, a polyalkylsiloxane is preferred, substituted with sufficient hydroxyl (silanol), methoxy/or ethoxy/groups for post-application crosslinking, and chemisorption or chemical bonding to the support with the catalyst thereon, and optionally, with some higher alkyl (ethyl, propyl, isopropyl, t-butyl) groups for improved stability. See also Canadian patent no. 1137025 and U.S. Pat. No. 4,190,515, which are incorporated herein by reference.

In the LPCE 104, the deuterium/water exchange equilibrium reaction shown in Equation 1 below takes place, in which the formation of liquid DTO is favored when heavy water is contacted with tritiated deuterium gas (DT). By virtue of the countercurrent flow, the tritium moves from the gaseous D2/DT stream to the liquid D2O/DTO stream. Consequently, the tritium content is concentrated in the water (DTO/D2O) in the LPCE column 104 below the feed point 106.

DT_{(g)}+D₂O₍ₗ₎↔DTO₍ₗ₎+D_{2(g)} [Equation 1]

Without any limitation and not being limited to any particular theory, the exchange of hydrogen isotopes between hydrogen gas and liquid water comprises the following steps: evaporation of water isotopologues at the liquid/gas-vapor interface from liquid water flowing down the column over inert packing; mixing of water isotopologues within the liquid water phase from the liquid/gas-vapor interface into the bulk of the liquid water; transport of water vapor to the catalyst particle through the upward flowing gas-vapor stream; diffusion of reactants (water and hydrogen isotopologues) into the catalyst particle; chemisorption of the reactants, isotope exchange reaction, and desorption of the reaction products (isotopically equilibrated water vapor and hydrogen); diffusion of the reaction products out of the catalyst particle; transport of isotopically equilibrated water vapor to the liquid surface through the upward flowing gas-vapor stream; mixing of isotopically equilibrated hydrogen into the upward flowing gas-vapor stream; and condensation of water isotopologues at the liquid/gas-vapor interface into liquid water flowing down the column over inert packing.

Exiting the LPCE column 104 at the first end 108 is a tritium-rich heavy water stream (D2O/DTO) 112. The tritium-rich heavy water stream 112 is fed to an electrolysis cell 114.

The electrolysis cell 114 separates the tritium-rich heavy water 112 stream into deuterium, tritiated deuterium and oxygen gases. Heavy water is depleted from the liquid as it is more easily electrolyzed. In other words, the lighter component is preferentially evolved with the gas, enriching the heavy component in the electrolysis cell liquid. Therefore, the concentration of the tritium in the electrolyser liquid further increases, according to Equations 2 and 3 below.

2DTO₍ₗ₎→2DT_{(g)}+O_{2(g)} [Equation 2]

2D₂O₍ₗ₎→D_{(g)}+O_{2(g)} [Equation 3]

As shown in FIGS. 1 and 2, the disclosed process and apparatus comprises downstream enrichment and tritium recovery for reuse.

Exiting the electrolysis cell 114 will be a tritium-enriched water 116 which is returned to the VPCE 14 of the TRF 12 (as shown in FIG. 1), gaseous D2/DT stream 118 which is flowed back into the first end 108 of the LPCE 104, and oxygen gas 120. Therefore, according to an embodiment, the disclosed process does not remove tritium from heavy water, but rather concentrates tritium in a small volume of heavy water for further processing and immobilization, for example.

According to one aspect of the present disclosure, the oxygen gas 120 produced in the electrolysis cell 114 comprises ¹⁷O isotope, and this produced oxygen gas 120 can be removed (as opposed to being recycled) according to the process 100. The removal of ¹⁷O isotope beneficially avoids accumulation of ¹⁴C that would otherwise occur and therefore addresses numerous regulatory, safety, and environmental emissions concerns.

Exiting the LPCE 104 at the second end 110 is a tritium-lean deuterium gas 122 which is flowed into a D2/O2 recombiner 124. Oxygen gas 126 comprising ¹⁶O from an external source (not shown) is also flowed into the D2/O2 recombiner 124. The tritium-lean deuterium gas 122 is recombined with the oxygen gas 126 to produce a tritium-lean D2O liquid 128. This tritium-lean D2O liquid 128 is “virgin grade” or “virgin grade” equivalent heavy water containing tritium levels near environmental levels. A portion 128a of the tritium-lean D2O liquid 128 is diverted back into the LPCE 104 for reflux and another portion 128b is diverted away as a product.

In some aspects, the D2/O2 recombiner 124 is an overhead recombiner.

In some aspects, the portion 128b can be diverted back to the heat transport system 22 to replenish any heavy water loss and where portion 128b is intended for circulation through the reactor fuel channels to remove heat produced by fission of natural uranium fuel. Therefore, virgin heavy water 128b is a marketable product_with broad applications including makeup water of a heat transport system (as part of ongoing operation, a small percentage of heavy water is lost). Such is one application of the produced virgin heavy water 128 by heavy water utilities.

The present process is a high-efficiency system that removes tritium in heavy water to near environmental level, and virtually free of all other radioactive elements. In some embodiments, the detritiation factor (DF) which is a ratio of tritium concentration in the input stream over the output stream is at least 400,000. By comparison, the DF of the existing TRF is 35.

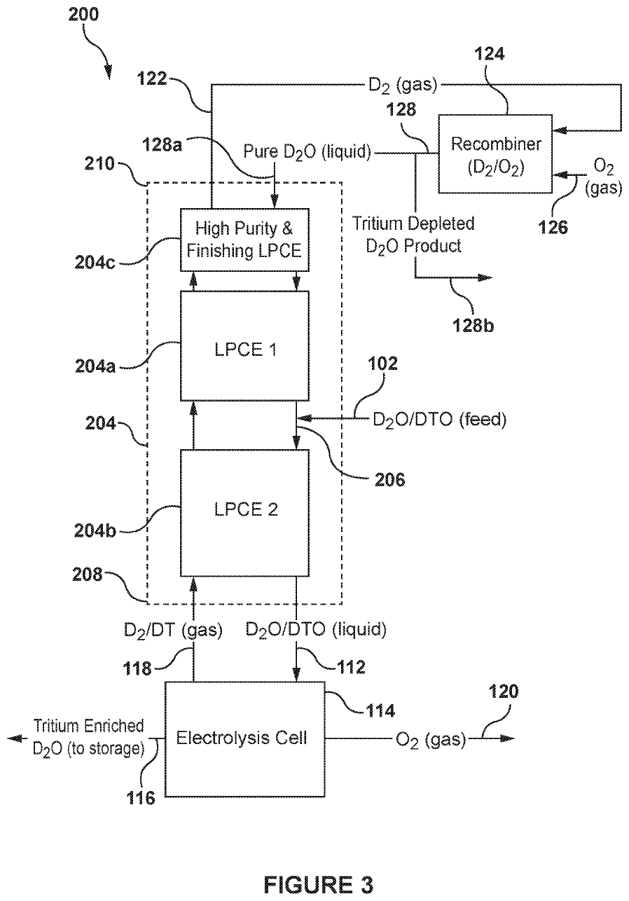

FIG. 3 shows an apparatus and a process according to another embodiment for a process for separating tritiated heavy water into a tritium-reduced stream and a tritium-enriched stream. Apparatus and process 200 is similar to process 100 for separating tritiated heavy water into a tritium-lean heavy water stream and a tritium-enriched heavy water stream. In this example, the VPCE 14 (not shown) of the TRF 12 (not shown) provides the source of tritiated heavy water (a mixture of DTO/D2O) feed 102 into a liquid phase catalytic exchange column (LPCE) 204. LPCE 204 comprises a plurality of LPCEs identified as LPCE1 204a, LPCE2 204b, and a finishing LPCE 204c which are fluidly interconnected to allow countercurrent flow as between a first end 208 and a second end 210 of the LPCE 204. As can be seen for this example, tritiated heavy water 102 enters the LPCE 204 at a feed point 206 to begin the process of tritium movement from the gaseous D2/DT stream to the liquid D2O/DTO stream. Without being limited to any particular theory, heavy water enriched in tritium will be produced below the feed point 206 and whereas tritium will be stripped above the feed point 206. In some embodiments, the feed point 206 is between LPCE1 204a and LPCE2 204b. Within the LPCE 204 in countercurrent isotope exchange, the tritium content is reduced in the gaseous D2/DT stream 122 moving in the direction from the LPCE1 204a to the LPCE2 204b, to the finishing LPCE 204c and exits at the second end 210 of the LPCE column 204, whereas the tritium content is increased in the liquid D2O/DTO stream 112 that exits out at the first end 208 of the LPCE 204.

It will be seen that in the present example of the invention as shown in FIG. 3, the arrangement of the plurality of liquid phase catalytic exchange columns 204a, 204b, and 204c, prevent cross contamination in the system because the finishing LPCE 204c is isolated from the system until the tritium profile in the other LPCE columns (e.g. 204a and 204b) have been established and is sufficiently low to utilize the finishing LPCE 204c.

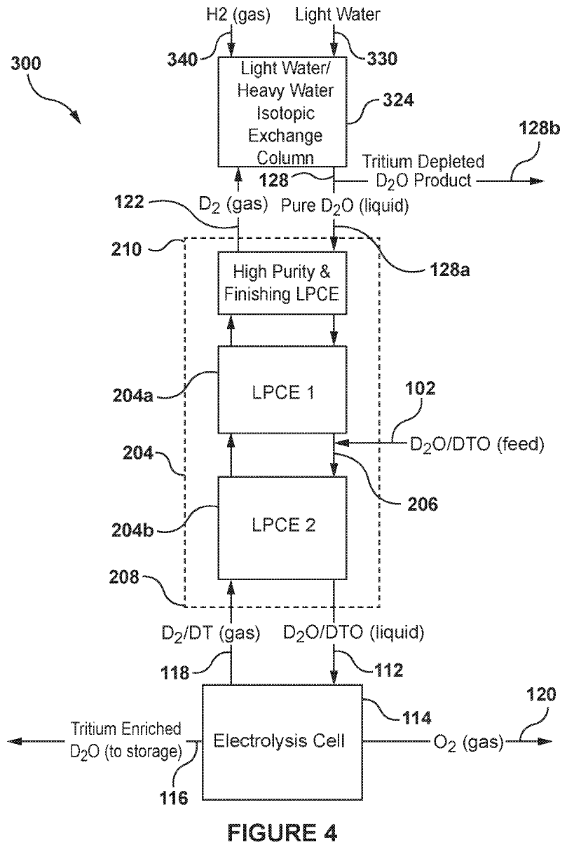

FIG. 4 shows an apparatus and a process according to another embodiment for a process for separating tritiated heavy water into a tritium-reduced stream and a tritium-enriched stream. Apparatus and process 300 is similar to processes 200 and 100 for separating tritiated heavy water (a mixture of DTO/D2O) feed 102 into a tritium-lean heavy water stream and a tritium-enriched heavy water stream. In this example, the tritium-lean deuterium gas 122 that exits the LPCE 204 at the second end 210 is flowed into a light water/heavy water isotopic exchange column 324 which is a scrubber to exchange deuterium from the LPCE 204 with a counter-current light water 330. The products of the light water/heavy water isotopic exchange column 324 are hydrogen 340 that can be vented to the atmosphere and the tritium depleted heavy water 128. Similarly, the tritium depleted heavy water 128 (i.e. virgin heavy water) can be portioned out so that the portion 128a can be returned to the LPCE column 204 as reflux and the portion 128b can be used for other applications including use by heavy water facilities as discussed above.

The embodiments of the present application described above are intended to be examples only. Those of skill in the art may effect alterations, modifications and variations to the particular embodiments without departing from the intended scope of the present application. In particular, features from one or more of the above-described embodiments may be selected to create alternate embodiments comprised of a subcombination of features which may not be explicitly described above. In addition, features from one or more of the above-described embodiments may be selected and combined to create alternate embodiments comprised of a combination of features which may not be explicitly described above. Features suitable for such combinations and subcombinations would be readily apparent to persons skilled in the art upon review of the present application as a whole. Any dimensions provided in the drawings are provided for illustrative purposes only and are not intended to be limiting on the scope of the invention. The subject matter described herein and in the recited claims intends to cover and embrace all suitable changes in technology.

What is claimed is:

1. A process for separating a tritiated heavy water stream into a tritium-lean heavy water stream and a tritium-enriched heavy water stream, the process comprising:
producing a source of tritiated heavy water (DTO/D2O);
flowing the tritiated heavy water (DTO/D2O) into an isotope exchange column at a feed point between a first end of the column and an opposed second end of the column, said column containing a hydrophobic solid catalyst configured to promote exchange of deuterium and tritium;
flowing a DT/D2 gas out of an electrolysis cell and into the first end of the column;
concentrating, in the column, tritium content in the tritiated heavy water by counter current flow of the DT/D2 gas from the first end of the column to the second end of the column, to produce a tritium-rich heavy water below the feed point and a tritium-lean deuterium gas above the feed point;
flowing the tritium-rich heavy water out the first end of the column and into the electrolysis cell;
forming, in the electrolysis cell, the DT/D2 gas and the tritium-enriched heavy water stream;
flowing the tritium-enriched heavy water stream back to the source of the tritiated heavy water;
flowing the tritium-lean deuterium gas out the second end of the column and into a tritium-lean heavy water unit;
flowing an O2 gas or light water into the tritium-lean heavy water unit; and
forming, in the tritium-lean heavy water unit, the tritium-lean heavy water stream.

2. The process of claim 1 further comprising:
refluxing a portion of the tritium-lean heavy water stream back into the second end of the column.

3. The process of claim 2 further comprising:
diverting another portion of the tritium-lean heavy water stream away to a remote site.

4. (canceled)

5. The process of claim 4 wherein the source of the tritiated heavy water comprises a vapor phase catalytic exchange column (VPCE) configured to receive the tritium-enriched heavy water stream.

6. (canceled)

7. The process of claim 1 wherein the hydrophobic solid catalyst is a platinum-based hydrophobic solid catalyst.

8. The process of claim 1 wherein the tritium-lean heavy water unit is a D2/O2 recombiner when configured to receive the O2 gas.

9. The process of claim 8 wherein the D2/O2 recombiner is a D2/O2 overhead recombiner.

10. The process of claim 1 wherein the tritium-lean heavy water unit is a light water/heavy water isotopic exchange column when configured to receive the light water and configured to additionally produce a hydrogen gas stream.

11. The process of claim 1 wherein the feed point is about mid-way between the first end and the second end.

12. The process of claim 1 wherein the forming, in the electrolysis cell, produces an oxygen gas.

13. The process of claim 12 further comprising diverting the produced oxygen gas away from the electrolysis cell.

14. The process of claim 13 wherein the produced oxygen gas comprises ¹⁷O.

15. The process of claim 1 wherein the isotope exchange column comprises a plurality of isotope exchange columns.

16. The process of claim 15 wherein the plurality of isotope exchange columns comprise: a first LCPE configured for receiving the tritiated heavy water (DTO/D2O) and flowing the tritium-rich heavy water out the first end of the column, a second LPCE emplaced between the first LPCE and the second end and fluidly connected to the first LPCE, and a high purity finishing LPCE emplaced between the second LPCE and the second end and fluidly connected to the second LPCE and configured for flowing the tritium-lean deuterium gas into the tritium-lean heavy water unit and for receiving at least a portion of the tritium-lean heavy water stream from the tritium-lean heavy water unit.

17. A system for producing a tritium-lean heavy water stream comprising:
a source of tritiated heavy water (DTO/D2O);
an isotope exchange column containing a hydrophobic solid catalyst, and configured for receiving tritiated heavy water (DTO/D2O) from the source, the column configured to promote exchange of deuterium and tritium to produce a tritium-rich heavy water and a tritium-lean deuterium gas;
an electrolysis cell configured for producing a DT/D2 gas and for flowing the DT/D2 gas into the isotope exchange column and configured for receiving the tritium-rich heavy water from the isotope exchange column and producing a tritium-enriched heavy water stream for flowing back to the source of tritiated heavy water (DTO/D2O); and
a tritium-lean heavy water unit configured for receiving the tritium-lean deuterium gas flowed from isotope exchange column and receiving an O2 gas or light water, to form the tritium-lean heavy water stream.

18. The system of claim 17 wherein the source comprises a vapour phase catalytic exchange column (VPCE) to produce the tritiated heavy water (DTO/D2O).

19. The system of claim 18 wherein the source further comprises an upgrader for producing, using the received tritium-enriched heavy water stream, a heavy water product for use by a moderator operatively connected to the VPCE.

20. The system of claim 17 wherein the tritium-lean heavy water unit is a D2/O2 recombiner for receiving the tritium-lean deuterium gas flowed from isotope exchange column and the O2 gas to form the tritium-lean heavy water stream or the tritium-lean heavy water unit is a light water/heavy water isotopic exchange column for receiving the tritium-lean deuterium gas flowed from isotope exchange column and the light water to form the tritium-lean heavy water stream and a hydrogen gas stream.

21. (canceled)

22. The system of claim 17 wherein the isotope exchange column is configured to receive the tritiated heavy water (DTO/D2O) at a feed point mid-way between a first end of the column and an opposed second end of the column.

23. The system of claim 17 wherein the isotope exchange column comprises a plurality of isotope exchange columns.

24. The system of claim 23 wherein the plurality of isotope exchange columns comprise: a first LCPE configured for receiving the tritiated heavy water (DTO/D2O) and flowing the tritium-rich heavy water out a first end of the column, a second LPCE emplaced between the first LPCE and a second end and fluidly connected to the first LPCE, and a high purity finishing LPCE emplaced between the second LPCE and the second end and fluidly connected to the second LPCE and configured for flowing the tritium-lean deuterium gas into the tritium-lean heavy water unit and for receiving at least a portion of the tritium-lean heavy water stream from the tritium-lean heavy water unit.
